(19) United States
(12) Patent Application Publication
(10) Pub. No.: US 2004/0044961 A1
(43) Pub. Date: Mar. 4, 2004

(54) Method and system for transformation of an extensible markup language document

(76) Inventor: Leonid Pesenson, Westfield, NJ (US)

Correspondence Address: MILBANK, TWEED, HADLEY & MCCLOY LLP, 1 CHASE MANHATTAN PLAZA, NEW YORK, NY, 10005-1413, US

(21) Appl. No.: 10/252,936

(22) Filed: Sep. 23, 2002

Related U.S. Application Data
(60) Provisional application No. 60/406,724, filed on Aug. 28, 2002.

(51) Int. Cl. G06F 15/00

(52) U.S. Cl. 715/513

(57) ABSTRACT

XPath expressions incorporated into an XSLT are used to map XML nodes in the generation of an HTML document, and also in the edit of the XML document using information input from the HTML document. A properties file representing name-value pairs of an XML document are used with a JSP to generate an HTML document, and also in the edit of the XML document using information input from the HTML document.

This application claims priority to U.S. Provisional Patent Application Ser. No. 60/406,724, filed Aug. 28, 2002, entitled Method And System For Transformation Of An Extensible Markup Language Document, the disclosure of which is incorporated herein by reference.

### BACKGROUND

1. Field of the Invention

The invention relates to the field of information display and management, and more particularly to the field of Extensible Markup Language (XML) documents and the use and edit of XML documents.

2. Description of the Related Art

It is known to use Extensible Stylesheet Language Transformations (XSLT) to transform Extensible Markup Language (XML) documents from one form to another form. These techniques frequently require a detailed knowledge of the XML document structure, and in particular the node structure, which is then hardcoded and incorporated in the XSLT. What is needed are methods and systems to provide greater flexibility in the use of XML, particularly for applications that modify the XML.

The preceding description is not to be construed as an admission that any of the description is prior art relative to the present invention.

### SUMMARY OF THE INVENTION

In one aspect, the invention provides a method and system for transforming an XML document, by creating an XPath expression that describes a node of the XML document. The XPath expression corresponds to a name-value pair in an XSLT template. Using the XSLT template and XPath expression, the method and system create an HTML document.

In one aspect, the invention provides a method and system for transforming an XML document by creating a properties file that describes a name-value pair of the XML document, reading the properties file into a properties object, and creating a JSP that generates an HTML form document using the properties file.

In another aspect, the invention provides a method and system for sending the HTML document to a client, receiving information responsive to the HTML document and changing the XML document to reflect the received information.

In another aspect, the invention provides a method and system for changing the XML document using the XPath expression.

In another aspect, the invention provides a method and system for creating forms in an HTML document.

In another aspect, the invention provides a method and system for capturing information entered into forms in an HTML document.

The foregoing specific aspects and advantages of the invention are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates a system according to one embodiment of the invention;

FIG. 2 illustrates a method according to one embodiment of the invention; and

FIG. 3 illustrates a method according to one embodiment of the invention.

It is understood that the drawings are for illustration only and are not limiting.

### DETAILED DESCRIPTION OF THE DRAWINGS

Declarative vs. Imperative programming. To understand one philosophy behind the invention, it is helpful to understand the difference between declarative and imperative programming. These differences have been described by David Mertz, Ph.D. of Gnosis Software Inc. XML Programming Paradigms (part Three); Declarative Programming with XML Stylesheet Language Transformations, December 2001, http://gnosis.cx/publish/programming/sml_models_xslt.html. Dr. Mertz notes that the most commonly used programming languages are predominantly imperative. In imperative languages exemplified by C, C++, Java, etc., the code lists a temporal collection of steps executed by the CPU. This includes logic so the program does not execute all the same steps in the same sequence regardless of input. Yet, each execution of an imperative program consists of actions that are performed for their “side-effects”—e.g. storing a value to a mutable variable or causing input/output to occur.

Dr. Mertz also notes that in contrast to imperative languages, there are several declarative languages. These are often divided into logical and functional variants. Logical languages include Prolog and Mercury, while functional languages include Lisp, Scheme, etc. Extensible Stylesheet Language Transformations (XSLT) is also clearly and strongly in the declarative family of programming languages. “[E]ven ‘little languages’ like specialized configuration files can be considered declarative also. Depending on just how limited they are, such configuration files may or may not be programming languages, but they are declarative either way.”

“Declarative programming has much more in common with mathematics than does traditional imperative programming (which is closer to certain engineering or mechanical practices).” Considering a set of three linear equations with three unknowns, as below:

10x+5y−7z+1=0

17x+5y −10z+3=0

5x −4y+3z−6=0

These equations “declare” a certain collection of relations. There is no temporal order in these declarations, and no “assignment” is really made to variables in this mathematical sense.

As Dr. Mertz notes, “[i]n order to solve these three equations with a computer, ultimately the CPU will carry out some series of instructions in linear temporal order.” However, “a declarative programmer does not want or need to worry about what the CPU actually does. She merely writes down statements of facts that make up the specification. Sometimes those statements involve intermediate placeholders and functions (in the mathematical sense of “function”), but these intermediaries are themselves unordered and non-assigning.”

One simple example of declarative programming is rule-based programming. This is usually done with the use of a language that allows the developer to state the rules that apply to the problem. The connections between the rules are not stated explicitly, but only through the triggers of the rules themselves. Behind the scenes, a complex mechanism may exist that knows how to process rules, prioritize them, determine which is to be triggered, etc. This code can optimize the processing without knowing anything about the application domain that the rules describe. The rule base therefore becomes the language for describing the problem. One can always append yet another rule without having to worry about how it will interact with other rules, as each rule leaves no side effects. Beyond a simple if/then statement, this methodology shows its power very quickly, as any significant number of rules would quickly become unmanageable and unmaintainable with the use of standard imperative techniques.

XSLT is in many ways similar to the Rules approach. XSLT's main construct is a template that is triggered when the right node of Extensible Markup Language (XML), determined by the template description, is encountered by the XSLT processor. There are other constructs in addition to the template that can be used in XSLT, but this is the main one. XML is also declarative by nature. The combination is very attractive as it allows one to create complex transformations using a rather large number of templates and other XSLT code that nevertheless remains maintainable and easily extensible. By using the XML/XSLT combination, one can also produce many different transformations of the XML that will result in new XML structure, HTML for web pages, PDF, RTF, etc.

In general the XML/XSLT combination is established for producing static HTML pages, and more people are experimenting with PDFs and using XSLT as glue to convert one form of XML into another.

In one embodiment, the method of the invention is unique because it uses XML with XSLT, and a bit of generic Java infrastructure, to edit and re-edit the original XML using HTML forms. This in effect creates a dynamic Graphical User Interface (GUI) for editing an XML model. The approach is very much like the standard Model-View-Controller mechanism that is a well-accepted paradigm in GUI development. XML can be thought of as the model, the XSLT is the view renderer, and the Java code to make the changes to the XML as specified through the HTML (produced by the XSLT), needs to know nothing about either one. As evidenced by the previous sentence there is a certain amount of circularity in this approach, which is its beauty. The XSLT is created from the XML, which then produces a GUI, which in turn modifies the underlying XML. The cycle can be repeated as much as necessary until the XML contains all the information required. It can then be passed on for more processing to some other process, but at this point it is just the clean XML with no connection to the GUI.

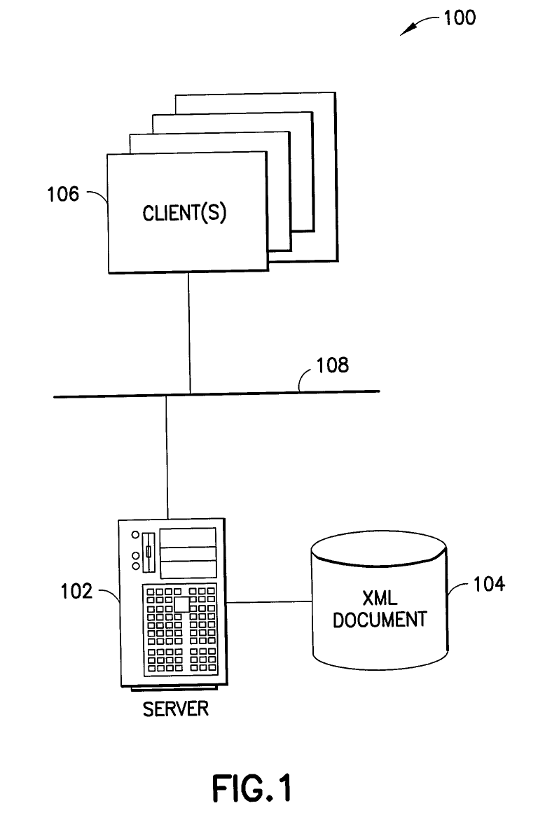

Referring to FIG. 1, a system 100 according to one embodiment of the invention includes a server 102 connected to a database 104 for holding/storing XML documents and a plurality of clients 106, which are interconnected to server 102 by network 108.

Examples are provided below using the system illustrated in FIG. 1 to contrast with the more standard approach that is generally not declarative. The standard approach is much heavier on Java code and puts a great deal of the system's business knowledge in the imperative Java code. This is in contrast to the embodiments of the invention, which put the business knowledge in the XML as well as inevitably some in the XSLT. Since the XML and XSLT are easier to maintain, this can be a major improvement to the system's maintainability and transparency.

The code below illustrates a straight-forward XML document, such as might be stored in database 104.

option.xml
“?xml version—“1.0”?>
<valuation>

<contracts>1</contracts>
<option>

<CallOption>

<ticker>MSFT</ticker>
<exercise>

<EuropeanExercise>

<expDate>1 Y</expDate>
<strike>100%</strike>

</EuropeanExercise>

</exercise>

</CallOption>

</option>
<price>?</price>

</ valuation >

In one standard approach to edit the XML document using HTML forms, the following code might be written:

Input Screen:

<html>

<head></head>
<body>

<form action=“Edit” method=“POST”>

Number of contracts: <input type=“text” name=“contracts” value=“1”/><br />
Ticker: <input type=“text” name=“ticker” value=“MSFT“/><br />
Expiration date: <input type=“text” name=“expDate” value=“1 Y”/><br />
Strike: <input type=“text” name=“strike” value“100%”/><br />
Price: <input type=“text” name=“price” value=“?”/><br />
<input type=“submit” value=“Price”/>

</form>

<body>

</html>

Whether the above is in a JSP or in an HTML file, a mapping to the XML is now required. As noted above, the default values are hard-coded in the HTML file even though they could come from the XML file. The name-value pairs that come as part of the request if the Price submit button is clicked with the defaults left in the fields are:

contracts->1

ticker->MSFT

expDate->1Y

strike->100%

price->?

To edit the XML in the standard approach, these name-value pairs have to be set into the appropriate XML nodes. At this point the standard approach is to walk the Document Object Model (DOM) tree, which is well known although not particularly easy to implement in code.

In one embodiment of the invention, a properties file that associates field names of the XML document with XPath expressions for the corresponding nodes, looks like:

contracts=/valuation/contracts

ticker=/valuation/option/*/ticker

expDate=/valuation/option/*/exercise/*/expDate

strike=/valuation/option/*/exercise/*/strike

price=/valuation/price

This properties file is read into a Properties object, and this way the Java code knows where to put the values in the XML nodes.

At this point assume that there is a query class called XpathQuery, and that for each XPath expression string there is an object of type XpathQuery. It is then possible to convert the above HTML page to a JSP such that:

<%

//Some code that gets the DOM object representing the XML called doc, and a
//Properties object called xpathMap

String Writer sw = new StringWriter( );
Serializer serializer =
SerializerFactory.getSerializerFactory(Method.XML).makeSerializer(

sw,
new OutputFormat(doc));

serializer.asDOMSerializer( ).serialize(doc);

%>
<html>

<head></head>
<body>

<form action=“Edit” method=“POST”>

<input type=“hidden” xmlDoc=“<%=URLEncoder.encode(sw.toString( ))%>:/>
Number of contracts: <input type=“text” name=“contracts” value=“<%=new

XpathQuery(xpathMap.get(“contracts”)).getValueFromNode(doc)%>”/><br />

Ticker: <input type=“text” name=“ticker” value=“<%=new

XpathQuery(xpathMap.get(“ticker”)).getValueFromNode(doc)%”/><br />

Expiration date: <input type=“text” name=“expDate” value“<%=new

XpathQuery(xpathMap.get(“expDate”)).getValueFromNode(doc)%”/><br />

Strike: <input type=“text” name=“strike” value=“<%=new

XpathQuery(xpathMap.get(“strike”)).getValueFromNode(doc)%”/><br />

Price: <input type=“text” name=“price” value=“<%=new

XpathQuery(xpathMap.get(“price”)).getValueFromNode(doc)%”/><br />

<input type=“submit” value=“Price”/>

</form>

<body>

<html>

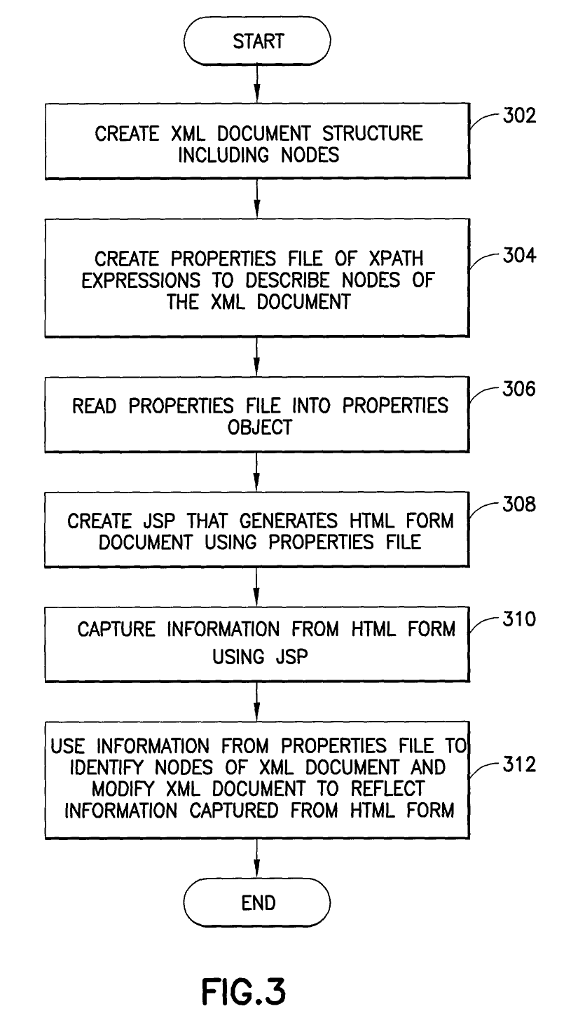

This approach is illustrated generally at FIG. 3, where at step 302, an XML document structure is created, including nodes of the XML document.

At step 304, a user of system 100 creates a properties file of XPath expressions to describe the nodes of the XML document.

At step 306, system 100 reads the property file into a properties object.

At step 308, a user of system 100 creates a JSP that generates an HTML form document using the information in the properties file. This HTML form document is sent to a client 106, where entries are made and the form submitted by the user.

At step 310, system 100 captures the information submitted in the HTML form using JSP.

At step 312, system 100 uses the information from the properties file to identify the appropriate nodes of the XML document and modify the XML document to reflect the information captured from the HTML form.

Of course as FIG. 3 illustrates, the same JSP that is used to generate the HTML form can be used to capture information that is input to the HTML form as well. One can also bypass the properties file by setting the values directly in the names of the fields and in the JSP expressions that set values for the fields.

This is an improvement on the earlier standard approach, since it is possible to modify the mappings without recompiling the Java code.

The code that edits the XML, which can be passed from the XML editor to some other service, simply iterates through the name-value pairs from the request and then uses XpathQuery objects to set the values into XML.

One draw back for this approach is that changes to the structure of the XML require some logic in the JSP to handle the changes. This logic has to be procedural since the code is in Java. The XML structure can be changed by having combo boxes whose values are entire fragments of XML.

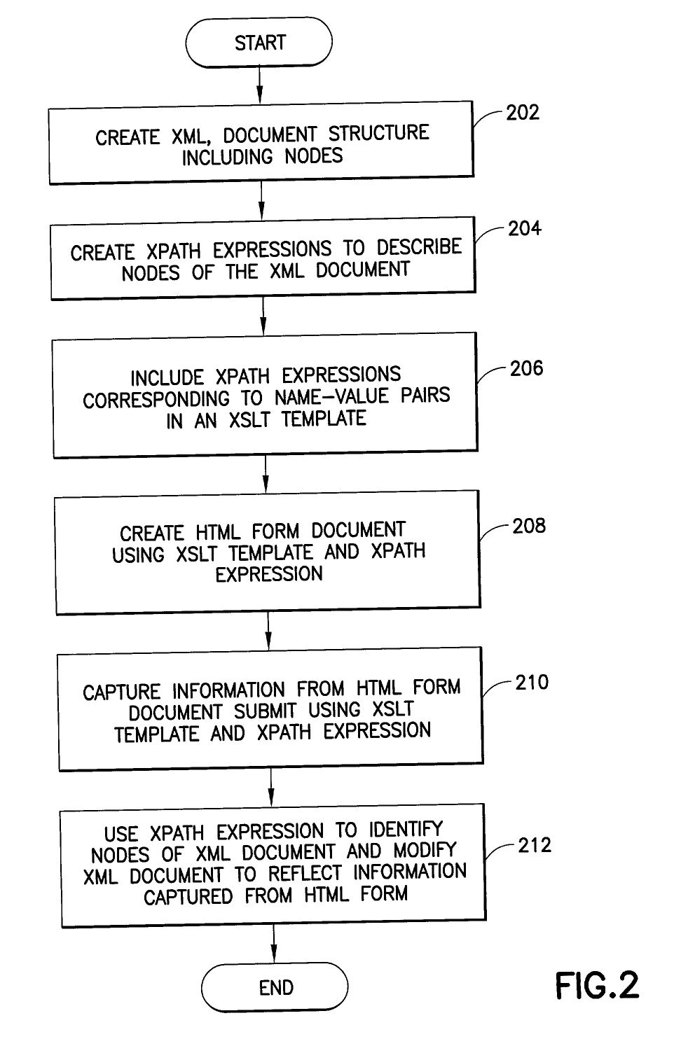

Another embodiment illustrated in FIG. 2 provides a more declarative and self-consistent approach. This embodiment eschews Java code for XSLT script when generating a GUI. In this embodiment, XSLT substitutes for both the JSP and the properties file. The XSLT is written so that the generated HTML contains widget names that are XPath expressions. It also is rule based, so that rules that do not match the given XML are not executed. Thus, one can have a rule that matches a member of a list and it will be invoked any time that member is found. If there is no list, then it is not invoked. Thus when the XML structure is changed the rules start to get invoked or cease to be invoked.

This embodiment is illustrated in the following XSLT screen generation:

<xsl:param name=“xmlDoc”/>
<xsl:template match=“/”>
<html>

<head></head>
<body>

<form action=“Edit” method=“POST”>

<input hidden=“xmlDoc” value=“$xmlDoc”/>
</xsl apply-templates/>

<input type=“submit” value=“Price”/>

</form>

<body>

</html>
</xsl:template>
xsl:template match=“contracts”>

Number of contracts: <input type=“text” name=“/valuation/{name(.)}”

value=“{.}”/><br/>
</xsl:template>
<xsl:template match=“price”>

Price: <input type=“text” name=“/valuation/{name(.)}” value=“{.}”/><br/>

</xsl:template>
<xsl:template match=“ticker”>

Ticker: <input type=“text” name=“/valuation/option/*/ticker” value=“{.}”/><br/>

</xsl:template>
<xsl:template match=“expDate”>

Expiration date: <input type=“text”

name=“/valuation/option/*/exercise/*/{name(.)}” value=“{.}”/><br/>
</xsl:template>
<xsl:template match=“strike”>

Strike: <input type=“text” name=“/valuation/option/*/exercise/*/{name(.)}”

value=“{.}”/><br/>
</xsl:template>

In the example above, the XSLT uses the XML to generate the form, and then changes in the form are reflected in the XML through the XSLT. This is illustrated in FIG. 2 where at step 202, an XML document structure is created, including nodes of the XML document.

At step 204, a user of system 100 creates XPath expressions to describe the nodes of the XML document.

At step 206, the user of system 100 includes the XPath expressions corresponding to name-value pairs in an XSLT template.

At step 208, system 100 uses the XSLT template to generate an HTML form document that includes the XPath expressions. This HTML form document is sent to a client 106, where entries are made and the form submitted by the user. The XPath expression is part of the XSLT template, and the expression corresponds to the XML nodes in the name attributes of the HTML INPUT or SELECT elements, whose value is placed into the XML at step 212. In this way, creating the XPath/value (name/value) pair makes the Java code generic.

At step 210, system 100 captures the information submitted in the HTML form using the XSLT template and the XPath expressions.

At step 212, system 100 uses the XPath expressions to identify the appropriate nodes of the XML document and modify the XML document to reflect the information captured from the HTML form.

The XML/XSLT approach described above, unifies three features: 1) HTML field generation; 2) naming of fields using XPath while generating the fields such that Java code is generic; and 3) default generation of HTML fields.

Although illustrative embodiments have been described herein in detail, it should be noted and will be appreciated by those skilled in the art that numerous variations may be made within the scope of this invention without departing from the principle of this invention and without sacrificing its chief advantages. Such variations include a further enhancement that can make the various XSLT/XML/Java embodiments even more attractive by moving the transformation infrastructure to client 106, as specifically a hidden applet. That with the help of some JavaScript makes the GUI extremely responsive even in those cases where the changes on the screen will cause the XML structure to change.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

I claim:

1. A method for transforming an XML document, the method comprising:
creating an XPath expression that describes a node of the XML document;
including the XPath expression corresponding to a name-value pair in an XSLT template; and
creating an html document that includes the XPath expression using the XSLT template.

2. A method according to claim 1, further comprising:
sending the html document to a client;
receiving information responsive to the html document; and
changing the XML document to reflect the received information.

3. A method according to claim 1, further comprising:
changing the XML document using the XPath expression.

4. A method according to claim 1, wherein the html document includes a form.

5. A method according to claim 1, wherein the html document includes a form and default information in the form is generated using the XPath expression.

6. Computer executable software code transmitted as an information signal, the code for transforming an XML document, the code comprising:
code to create an XPath expression that describes a node of the XML document;
code to include the XPath expression corresponding to a name-value pair in an XSLT template; and
code to create an html document that includes the XPath expression using the XSLT template.

7. A computer-readable medium having computer executable software code stored thereon, the code for transforming an XML document, the code comprising:
code to create an XPath expression that describes a node of the XML document;
code to include the XPath expression corresponding to a name-value pair in an XSLT template; and
code to create an html document that includes the XPath expression using the XSLT template.

8. A programmed computer for transforming an XML document, comprising:
a memory having at least one region for storing computer executable program code; and
a processor for executing the program code stored in the memory; wherein the program code comprises:
code to create an XPath expression that describes a node of the XML document;
code to include the XPath expression corresponding to a name-value pair in an XSLT template; and
code to create an html document that includes the XPath expression using the XSLT template.

9. A method for transforming an XML document, the method comprising:
creating a properties file that describes a name-value pair of the XML document;
reading the properties file into a properties object; and
creating a JSP that generates an html form document using the properties file.

10. A method according to claim 9, further comprising:
sending the html document to a client;
receiving information responsive to the html document; and
changing the XML document to reflect the received information.

11. A method according to claim 9, further comprising:
changing the XML document using information from the properties file.

12. Computer executable software code transmitted as an information signal, the code for transforming an XML document, the code comprising:
code to create a properties filed that describes a name-value pair of the XML document;
code to read the properties file into a properties object; and
code to create a JSP that generates an html form document using the properties file.

13. A computer-readable medium having computer executable software code stored thereon, the code for transforming an XML document, the code comprising:
code to create a properties filed that describes a name-value pair of the XML document;
code to read the properties file into a properties object; and
code to create a JSP that generates an html form document using the properties file.

14. A programmed computer for transforming an XML document, comprising:
a memory having at least one region for storing computer executable program code; and
a processor for executing the program code stored in the memory; wherein the program code comprises:
code to create a properties filed that describes a name-value pair of the XML document;
code to read the properties file into a properties object; and
code to create a JSP that generates an html form document using the properties file.
